(19) United States
(12) Patent Application Publication
(10) Pub. No.: US 2018/0073524 A1
(43) Pub. Date: Mar. 15, 2018

(54) HYDRAULIC ACTUATOR CONTROL SYSTEM

(71) Applicant: HydraForce, Inc., Lincolnshire, IL (US)

(72) Inventor: Travis Schmidt, Oregon City, OR (US)

(21) Appl. No.: 15/676,980

(22) Filed: Aug. 14, 2017

Related U.S. Application Data
(60) Provisional application No. 62/374,423, filed on Aug. 12, 2016.

(51) Int. Cl. F15B 11/10; F15B 1/26; F15B 13/04; F15B 13/02

(52) U.S. Cl. CPC F15B 11/10; F15B 1/265; F15B 13/0417; F15B 13/026; F15B 2211/351; F15B 2211/36; F15B 2211/7053; F15B 2211/465; F15B 2211/6057; F15B 2211/6316; F15B 2211/6313; F15B 2211/6654; F15B 2211/455

(57) ABSTRACT

A hydraulic actuator control system performs pressure compensation in the system by monitoring the pressure differential across a meter-out device. A flow of fluid can be directed from a pump through a meter-in device to a chamber of an actuator via a first port. In response to the flow of fluid entering the first port of the actuator, a return flow of fluid can be directed from a second port of the actuator through the meter-out device to a tank. The meter-in device can monitor a pressure differential across the meter-out device. The meter-in device can control the flow of the fluid from the pump to the actuator to place the pressure differential across the meter-out device within a desired range.

### CROSS-REFERENCE TO RELATED APPLICATIONS

This patent application claims the benefit of priority to U.S. Provisional Patent Application No. 62/374,423, filed Aug. 12, 2016, and entitled, “Hydraulic Actuator Control System of Vehicle,” which is incorporated in its entirety herein by this reference.

### TECHNICAL FIELD

This patent disclosure relates generally to a hydraulic actuator control system and, more particularly, to a hydraulic actuator control system where a combination of valves is used to control the movement of a hydraulic actuator of a vehicle.

### BACKGROUND

Vehicles, such as, telehandlers, backhoe loaders, wheel loaders, tractors, excavators, etc., can include one or more actuators configured to selectively manipulate an implement. Typically, such an actuator is a hydraulic actuator that is controlled via a hydraulic actuator control system The hydraulic actuator control system can include a combination of valves used to control the movement (e.g., over a reciprocal extending/retracting range of travel or in rotational clockwise/counterclockwise directions) of a hydraulic actuator of the vehicle.

Various systems have been used before to act as the hydraulic actuator control system. For example, single spool systems use a fixed arrangement between the meter-in and meter-out orifices. Since the meter-in and meter-out orifices have a fixed relationship, there is no chance for energy savings when the actuator is used for lowering functions.

In traditional two coil bridge circuits, the actuator and counterbalance or load reactive valves for metering out are inherently inefficient. The inefficiency in this system is caused by the need to set the counterbalance valves at one hundred thirty percent of the highest load. Lowering this setting requirement can create a high pressure difference at the meter-out device when the load-induced pressures are low. When the load-induced pressures are low, the system or pump pressure must be high in order to pilot open the meter out valves.

A four coil bridge circuit may provide energy-saving benefits, but it requires additional components in the form of sensors, additional coils, and an expensive electronic control unit (ECU) to carry out energy-saving control algorithms.

U.S. Pat. No. 4,510,751 is entitled, “Outlet Metering Load-Sensing Circuit,” and is directed to a meter-out load sensing hydraulic system that controls one or more motors and is supplied by a variable displacement pump through a directional control valve. The compensating means of the pump senses pressure and flow on the discharge or return side of the motor to determine the pump cam plate position. The signal line connecting this discharge side of the motor to the compensating means is also supplied with a low pressure signal flow which causes the pump to standby at a low pressure level in a neutral valve position or when metering down a gravity load.

It will be appreciated that this background description has been created by the inventor to aid the reader, and is not to be taken as an indication that any of the indicated problems were themselves appreciated in the art. While the described principles can, in some aspects and embodiments, alleviate the problems inherent in other systems, it will be appreciated that the scope of the protected innovation is defined by the attached claims, and not by the ability of any disclosed feature to solve any specific problem noted herein.

### SUMMARY

The present disclosure, in one aspect, is directed to embodiments of a hydraulic circuit configured to reduce the complexity and cost of the combination of valves used in a hydraulic actuator control system while maintaining equivalent or improved performance compared to existing solutions. In addition, the present disclosure, in another aspect, is directed to embodiments of a hydraulic actuator control system in which pressure compensation in the system is performed by monitoring the pressure differential across the meter-out orifice or device. In embodiments, the pressure in a pilot port of a compensator is referenced to the pressure on a meter-out side of an actuator.

In one embodiment, a hydraulic actuator control system includes a tank, a pump, an actuator, a meter-in device, and a meter-out device. The tank is adapted to hold a reservoir of fluid. The pump is in fluid communication with the tank. The pump is adapted to receive a supply of fluid from the tank and to discharge a flow of fluid.

The actuator is in selective fluid communication with the pump and the tank. The actuator defines a first port, a second port, and a chamber therein. The first and second ports are in communication with the chamber. The chamber is adapted to receive the flow of fluid from the pump.

The meter-in device is interposed between the pump and the actuator. The meter-in device is adapted to selectively direct the flow of fluid from the pump to at least one of the first and second ports of the actuator. The meter-out device is interposed between the actuator and the tank. The meter-out device is adapted to selectively direct a return flow of fluid from at least the other of the first and second ports of the actuator to the tank.

The meter-in device is adapted to monitor a pressure differential across the meter-out device of the return flow of fluid moving to the tank. The meter-in device is adapted to control the flow of fluid from the pump to the actuator based upon the pressure differential across the meter-out device.

In another embodiment, a method of controlling a hydraulic actuator includes directing a flow of fluid from a pump through a meter-in device to a chamber within an actuator via a first port. In response to the flow of fluid entering the first port of the actuator, a return flow of fluid is directed from a second port of the actuator through a meter-out device to a tank. The meter-in device monitors a pressure differential across the meter-out device. The meter-in device controls the flow of fluid from the pump to the actuator to place the pressure differential across the meter-out device within a desired range.

Further and alternative aspects and features of the disclosed principles will be appreciated from the following detailed description and the accompanying drawings. As will be appreciated, the hydraulic circuits, components, and methods disclosed herein are capable of being carried out in other and different embodiments, and capable of being modified in various respects. Accordingly, it is to be understood that both the foregoing general description and the following detailed description are exemplary and explanatory only and do not restrict the scope of the appended claims.

### BRIEF DESCRIPTION OF THE DRAWINGS

FIG. 1 is a schematic view of an embodiment of a hydraulic circuit in accordance with principles of the present disclosure, the hydraulic circuit including a spool-type directional valve.

FIG. 2 is a schematic view of another embodiment of a hydraulic circuit in accordance with principles of the present disclosure, the hydraulic circuit including a pair of poppet-type proportional valves.

It should be understood that the drawings are not necessarily to scale and that the disclosed embodiments are illustrated diagrammatically and in partial views. In certain instances, details which are not necessary for an understanding of this disclosure or which render other details difficult to perceive may have been omitted. It should be understood that this disclosure is not limited to the particular embodiments illustrated herein.

### DETAILED DESCRIPTION OF EXEMPLARY EMBODIMENTS

Embodiments of a hydraulic actuator control system constructed in accordance with principles of the present disclosure are adapted to control the operation of an actuator of a vehicle (e.g., telehandlers, backhoe loaders, wheel loaders, tractors, excavators). Embodiments of a hydraulic actuator control system constructed in accordance with principles of the present disclosure can have the same or similar functionality as conventional circuits, but with reduced cost, complexity and/or power-consumption requirements.

Embodiments of a hydraulic actuator control system constructed in accordance with principles of the present disclosure can perform pressure compensation in the system by monitoring the pressure differential across the meter-out orifice or device. In embodiments of a hydraulic actuator control system constructed in accordance with principles of the present disclosure a proportional meter out valve can be used in lieu of a traditional counterbalance valve or load-holding valve.

In embodiments, a hydraulic actuator control system constructed in accordance with principles of the present disclosure can reduce power requirements by allowing the actuator to move to a retracted or lowered position by the action of gravity. In other words, no assistance from the prime mover or hydraulic pump is needed to move an actuator if there are sufficient external forces such as gravity to assist such movement. In addition, embodiments of a hydraulic actuator control system constructed in accordance with principles of the present disclosure can operate without the use of complex software requiring fast processing electronic control units (ECU's) (or additional sensors associated therewith) for the function of low-power gravity assist this system.

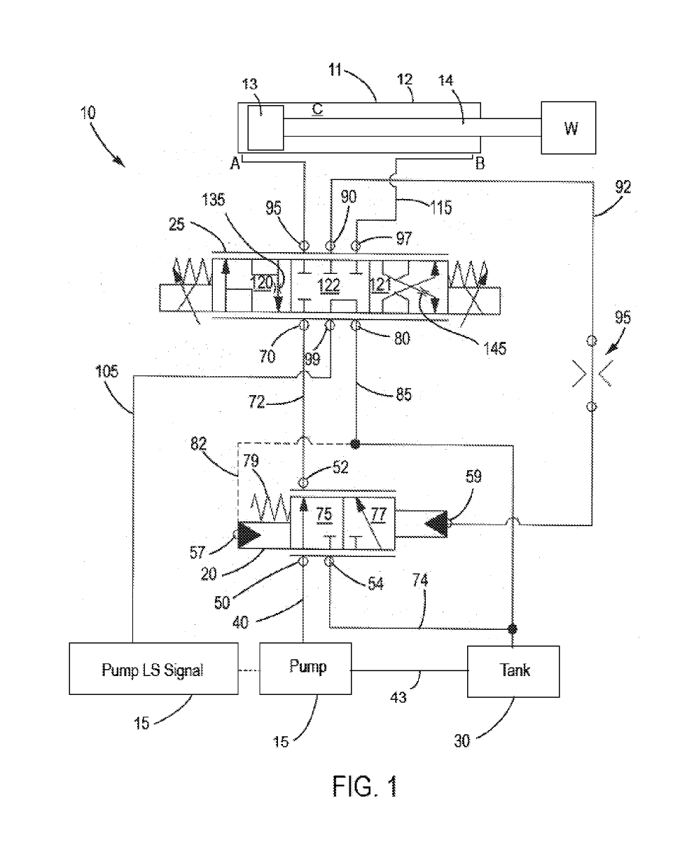

Turning now to the Figures, an embodiment of a hydraulic actuator control system 10 constructed according to principles of the present disclosure is shown in FIG. 1. In embodiments, the hydraulic actuator control system 10 can be used to selectively operate a hydraulic actuator 11. The illustrated hydraulic actuator includes a body and a piston assembly disposed within the body and being reciprocally movable over a range of travel between a retracted position and an extended position. The piston assembly includes a piston 13 and a rod 14, at least a portion of which extends from the body 12. The body 12 defines an internal chamber C with a first port A and a second port B in communication therewith. The piston 13 is movably disposed within the chamber of the body to define a variable volume piston-side chamber in communication with the A port and a rod-side chamber in communication with the B port.

The hydraulic actuator control system 10 includes a pump 15, a meter-in device 20 in the form of a compensator, a meter-out device 25 in the form of a directional control valve, and a tank 30 adapted to hold a reservoir of fluid. The actuator 11 is in selective fluid communication with the pump 15 and the tank 30. The chamber C of the actuator 11 is adapted to receive the flow of fluid from the pump 15 via one of the first and second ports A, B. The pump 15 is in fluid communication with the tank 30. The pump 15 is adapted to receive a supply of fluid from the tank 30 and to discharge a flow of fluid therefrom.

In embodiments, the pump 15 can be any suitable pump that is acceptable for the intended application, as will be readily understood by one skilled in the art. In embodiments, the pump 15 can be a fixed-displacement pump or a variable-displacement pump. The pump 15 is in fluid communication with the compensator 20 via a compensator supply line 40 to selectively deliver a flow of hydraulic fluid to the compensator 20. In embodiments, the pump can be in fluid communication with the tank 30 via any suitable technique. For example, in embodiments, the pump 15 is in fluid communication with the tank 30 via a pump supply line 43 to receive a return flow of hydraulic fluid from the tank 30, which in turn can be used by the pump 15 to deliver the flow of hydraulic fluid to the compensator 20.

The meter-in device 20 is interposed between the pump 15 and the actuator 11. The meter-in device 20 is adapted to selectively direct the flow of fluid from the pump 15 to at least one of the first and second ports A, B of the actuator 11. The meter-out device 25 is interposed between the actuator 11 and the tank 30. The meter-out device 25 is adapted to selectively direct a return flow of fluid from at least the other of the first and second ports A, B of the actuator 11 to the tank 30. In embodiments, the meter-in device 20 is adapted to monitor a pressure differential across the meter-out device 25 of the return flow of fluid moving to the tank 30, and the meter-in device 20 is adapted to control the flow of fluid from the pump 15 to the actuator 11 based upon the pressure differential across the meter-out device 25.

In embodiments, the compensator 20 is configured to function as an adaptive meter-in control element. In embodiments, the compensator 20 is adapted to monitor a proportional meter out orifice of the directional control valve 25 that is positioned within the exit flow path of hydraulic fluid leaving the actuator 11 based on a predetermined desired bias pressure. The compensator 20 can be adapted to control the amount of the flow of the hydraulic fluid from the compensator supply line 40 to the actuator 11 (via the directional control valve 25) to provide the desired pressure drop across the particular meter out proportional orifice.

In the illustrated embodiment, the compensator 20 includes a pump port 50, a control valve inlet port 52, a tank port 54, a first pilot port 57, and a second pilot port 59. The compensator supply line 40 is connected to the pump port 50 of the compensator 20 to fluidly connect the pump 15 and the compensator 20. The control valve inlet port 52 of the compensator 20 is in fluid communication with an inlet port 70 of the directional control valve 25 via a control valve supply line 72. The tank port 54 of the compensator 20 is in fluid communication with the tank 30 via an auxiliary compensator supply line 74 to fluidly connect the compensator 20 and the tank 30.

In embodiments, the compensator 20 is configured to be movable between a pump position 75 and a tank position 77. When the compensator 20 is in the pump position 75, the pump 15 is in fluid communication with the control valve inlet port 52 of the compensator 20 via the compensator supply line 40 and through the pump position 75 of the compensator 20, and the tank 30 is fluidly isolated from the control valve inlet port 52. When the compensator is in the tank position 77, the tank 30 is in fluid communication with the control valve inlet port 52 of the compensator 20 via the auxiliary compensator supply line 74 and through the tank position 77 of the compensator 20, and the pump 15 is fluidly isolated from the control valve inlet port 52. In the illustrated embodiment, the compensator 20 includes a compensator spring 79 adapted to bias the compensator 20 to the pump position 75.

In embodiments, the compensator 20 is adapted to monitor the pressure differential across a meter-out device of the directional valve 25 that is interposed along the exit flow of hydraulic fluid from the actuator 11. In embodiments, the pressure in the first pilot port 57 of the compensator 20 is referenced to the pressure at a meter-out port 80 of the directional control valve 25 downstream of a meter-out device in the form of an orifice provided by the directional control valve, and the pressure in the second pilot port 59 is referenced to the pressure at a meter-out side of the actuator 11 upstream of the meter-out orifice provided by the directional control valve 25.

The compensator port 90 of the directional control valve 25 is upstream of the orifices of the directional control valve 25, and the pressure in the second pilot port 59 is referenced to the pressure at the meter-out side of the actuator 11 upstream of the orifices of the directional control valve 25. The meter-out port 80 of the directional control valve 25 is downstream of the orifices of the directional control valve 25 such that the pressure in the first pilot port 57 of the compensator 20 is referenced to the pressure at the meter-out port 80 of the directional control valve 25 downstream of the respective orifice provided. As such, a pilot pressure difference between the first and second pilot ports 59, 57 corresponds to the pressure differential across the meter-out device 25 of the return flow of fluid moving to the tank 30.

In the illustrated embodiment, the first pilot port 57 of the compensator 20 is in fluid communication with the meter-out port 80 of the direction control valve 25 via a pilot line 82 tied into a tank return line 85 that fluidly connects the meter-out port 80 of the direction control valve 25 with the tank 30. The second pilot port 59 of the compensator 20 is in fluid communication with a compensator port 90 of the direction control valve 25 via a compensator return line 92.

In embodiments, a dampener device 95 can be fluidly interposed between the compensator port 90 of the directional control valve 25 and the second pilot port 59 of the compensator 20. In the illustrated embodiment, the compensator return line 92 is provided with a dampener device 95 to provide a dampening function. In embodiments, any suitable dampening device can be used, as will be readily understood by one skilled in the art.

The compensator 20 is adapted to allow the inlet port 70 of the directional control valve 25 to be in fluid communication with the tank 30 to have access to tank pressure if the load-induced pressure is sufficient. Under such conditions, the compensator 20 moves to the tank position 77, and hydraulic fluid can flow from the tank 30 through the auxiliary compensator supply line 74 out the compensator 20 via the control valve inlet port 52 and to the inlet port 70 of the directional control valve 25. If the load-induced pressure is not sufficient, then the compensator 20 will shift to the pump position 75 to achieve the desired meter-out pressure drop to satisfy the spring bias generated by the spring 79 of the compensator 20.

In embodiments, the compensator 20 is adapted to move to the tank position 77 to allow the inlet port 70 of the directional control valve 25 to be in fluid communication with the tank 30 to have access to tank pressure when the load-induced pressure exceeds a threshold level. When the load-induced pressure is below the threshold level, the compensator spring 79 is adapted to move the compensator 20 to the pump position 75 to achieve a desired meter-out pressure drop based upon a spring bias generated by the compensator spring 79.

The directional control valve 25 is adapted to selectively direct the flow of hydraulic fluid from the compensator 20 to one of the sides of the actuator 11 and to direct the return flow of hydraulic fluid from the other side of the actuator 11 to the tank 30. In embodiments, the directional control valve 25 is adapted to meter the flow of hydraulic fluid out of the actuator 11. In embodiments, the meter-out device 25 includes at least one orifice through which the return flow of fluid passes. In embodiments, the directional control valve 25 is also adapted to enable the compensator 20 to have access to the meter-out orifice that is interposed along the return flow of hydraulic fluid from the actuator 11 to the tank 30. The directional control valve 25 and the compensator 20 can be selectively fluidly connected such that the respective orifice through which the return flow of fluid is passing is also fluidly connected to the compensator 20. In embodiments, the directional control valve 25 can comprise any suitable valve or assembly of valves, as will be appreciated by one skilled in the art.

In the illustrated embodiment, the compensator 20 is in fluid communication with the proportional directional control valve 25 such that the compensator 20 is adapted to selectively direct the flow of fluid from the pump 15 to the proportional directional control valve 25. The proportional directional control valve 25 is adapted to selectively direct the flow of fluid from the compensator 20 to one of first and second ports A, B of the actuator 11 and to direct the return flow of fluid from the other of the first and second ports A, B of the actuator 11 to the tank 30. The proportional directional control valve 25 includes a respective orifice adapted to meter the return flow of fluid out of the first port A and the second port B of the actuator 11 to the tank 30 in a metered fashion.

In the illustrated embodiment, the directional control valve 25 comprises a spool-type directional control valve. The illustrated directional control valve 25 includes the inlet port 70, the meter-out port 80, the compensator port 90, a first or “A” work port 95, a second or “B” work port 97, and a load sense port 99. The inlet port 70 of the directional control valve 25 is in fluid communication with the control valve inlet port 52 of the compensator 20 via the control valve supply line 72. The meter-out port 80 of the direction control valve 25 is in fluid communication with the tank 30 via the tank return line 85 and is in fluid communication with the first pilot port 57 of the compensator 20 via the pilot line 82.

In the illustrated embodiment, a load sense line 105 is in fluid communication with the load sense port 99 of the directional control valve 25. The load sense line 105 can be in fluid communication with the load sense port 99 of the directional control valve 25. The load sense line 105 is adapted to provide a load sense signal to the pump 15. The pump 15 can be adapted to vary the flow of fluid in response to the load sense signal to generate a desired pressure at the actuator 11. In embodiments, the load sense line 105 can be arranged with a load sense pump, a system using a gear pump and a bypass compensator, a sensor of an electric load sense arrangement, or any other suitable equipment, as one of ordinary skill in the art would appreciate, whereby a flow of hydraulic fluid is directed to the actuator 11 to achieve the desired pressure at the actuator 11.

The A work port 95 of the directional control valve 25 is in fluid communication with an A side of the actuator 11 via an A-side line 110. The B work port 97 of the directional control valve 25 is in fluid communication with a B side of the actuator 11 via a B-side line 115. The compensator port 90 of the direction control valve 25 is in fluid communication with the second pilot port 59 of the compensator 20 via the compensator return line 92.

In embodiments, the directional control valve 25 is adapted to be movable between a first port or “A-side” fill position 120, a second port or “B-side” fill position 121, and a neutral position 122. In the A-side fill position 120, the A-side of the actuator 11 is in fluid communication with one of the pump 15 and the tank 30 to receive a flow of hydraulic fluid therein to fill the A-side of the actuator 11 with hydraulic fluid, and the B-side of the actuator 11 is in fluid communication with the tank 30 to drain hydraulic fluid from the B-side of the actuator 11 to the tank 30. When the directional control valve 25 is in the first-port fill position 120, the first port A of the actuator 11 is in fluid communication with one of the pump 15 and the tank 30 to receive a flow of fluid therein to fill the first side A of the actuator 11 with fluid, and the second port B of the actuator 11 is in fluid communication with the tank 30 to drain fluid from the second side B of the actuator 11 to the tank 30.

In the B-side fill position 121, the B-side of the actuator 11 is in fluid communication with one of the pump 15 and the tank 30 to receive a flow of hydraulic fluid therein to fill the B-side with hydraulic fluid, and the A-side of the actuator 11 is in fluid communication with the tank 30 to drain hydraulic fluid from the A-side of the actuator 11 to the tank 30. When the directional control valve 25 is in the second-port fill position 121, the second port B of the actuator 11 is in fluid communication with one of the pump 15 and the tank 30 to receive a flow of fluid therein to fill the second side B of the actuator 11 with fluid, and the first port A of the actuator 11 is in fluid communication with the tank 30 to drain fluid from the first side A of the actuator 11 to the tank 30.

In the neutral position 122, the actuator 11 is fluidly isolated from each of the pump 15 and the tank 30 such that the position of the actuator 11 is maintained, or held in place. In the illustrated embodiment, the directional control valve 25 is biased to the neutral position 122.

In the A-side fill position 120, the inlet port 70 of the directional control valve 25 is in fluid communication with the A-side of the actuator 11 through the A-side fill position 120 of the directional control valve 25 and the A-side line 110 connected to the A port 95 of the directional control valve 25. The inlet port 70 is also in fluid communication with the load sense port 99 through the A-side fill position 120 of the directional control valve 25.

In the A-side fill position 120, the B-side of the actuator 11 is in fluid communication with the meter-out port 80 of the directional control valve 25 through the B-side line 115 connected to the B port 97 of the directional control valve 25 and through the A-side fill position 120 of the directional control valve 25. The B port 97 is also in fluid communication with the compensator port 90 through the A-side fill position 120 of the directional control valve 25. In the illustrated embodiment, the directional control valve 25 includes a B-side meter out device 135 in the form of an outlet orifice that is adapted to control the flow of the hydraulic fluid through directional control valve 25 from the B-side of the actuator 11 to the tank 30 when the directional control valve 25 is in the A-side fill position 120.

In the illustrated embodiment, the B-side outlet orifice 135 is disposed downstream of the branch leading to the compensator port 90 such that the B-side outlet orifice 135 controls the flow of hydraulic fluid from the B-side of the actuator 11 to the meter-out port 80 of the directional control valve 25 but that the flow of hydraulic fluid from the B-side of the actuator 11 to the compensator port 90 bypasses the B-side outlet orifice 135. In that way, the pressure in the compensator return line 92 relates to the pressure at the B-side of the actuator 11 upstream of the B-side outlet orifice 135 and the pressure in the pilot line 82 relates to the pressure at the meter-out port 80 of the directional control valve 25 downstream of the B-side outlet orifice 135 when the directional control valve is in the A-side fill position 120.

In embodiments, the B-side fill position 121 is a mirror image of the A-side fill position 120. In the B-side fill position 121, the inlet port 70 of the directional control valve 25 is in fluid communication with the B-side of the actuator 11 through the B-side fill position 121 of the directional control valve 25 and the B-side line 115 connected to the B port 97 of the directional control valve 25. The inlet port 70 is also in fluid communication with the load sense port 99 through the B-side fill position 121 of the directional control valve 25.

In the B-side fill position 121, the A-side of the actuator 11 is in fluid communication with the meter-out port 80 of the directional control valve 25 through the A-side line 110 connected to the A port 95 of the directional control valve 25 and through the B-side fill position 121 of the directional control valve 25. The A port 95 is also in fluid communication with the compensator port 90 through the B-side fill position 121 of the directional control valve 25. In the illustrated embodiment, the directional control valve 25 includes an A-side meter out device 145 in the form of an outlet orifice that is adapted to control the flow of the hydraulic fluid through directional control valve 25 from the A-side of the actuator 11 to the tank 30 when the directional control valve 25 is in the B-side fill position 121.

In the illustrated embodiment, the A-side meter-out device 145 is disposed downstream of the branch leading to the compensator port 90 such that the A-side outlet orifice 145 controls the flow of hydraulic fluid from the A-side of the actuator 11 to the meter-out port 80 of the directional control valve 25, but that the flow of hydraulic fluid from the A-side of the actuator 11 to the compensator port 90 bypasses the A-side outlet orifice 145. In that way, the pressure in the compensator return line 92 relates to the pressure at the A-side of the actuator 11 upstream of the A-side outlet orifice 145 and the pressure in the pilot line 82 relates to the pressure at the meter-out port 80 of the directional control valve 25 downstream of the A-side outlet orifice 145 when the directional control valve is in the B-side fill position 121.

In the neutral position 122, the load sense port 99 is in fluid communication with the meter-out port 80 of the directional control valve 25. The inlet port 70, the A port 95, the B port 97, and the compensator port 90 are each in independent fluid isolation from all of the other ports of the directional control valve 25 when the valve 25 is in the neutral position 122. As such, when the directional control valve 25 is in the neutral position 122, the actuator 11 is held in place. In the illustrated embodiment, the hydraulic actuator control system 10 does not require an additional counter-balance valve or a load-holding valve.

The hydraulic actuator control system 100 can be used to perform automatic gravity lowering. Advantageously, no additional ECU or sensors are needed to perform gravity lowering. In the illustrated embodiment, when the actuator 11 is in an extended position (and is being operated to support a load under the effect of gravity), the directional control valve 25 can be placed in the B-side fill position 121 in order to retract the actuator 11 under the effect of gravity. The weight of the load W supported by the actuator 11 can operate to generate pressure within the hydraulic fluid on the B-side of the actuator 11, which in turn can flow out of the actuator 11 through the B-side fill position 121 of the directional control valve 25 to the tank 30. The actuator 11 can retract in response to the flow of hydraulic fluid out from the B-side of the actuator 11 without the operation of the pump 15.

In embodiments, the meter-out device for each of the A-side and the B-side of the actuator 11 can be hydraulic piloted or electro-proportional. In embodiments, each meter-out device can be configured to control the amount of hydraulic fluid flowing from the actuator 11 to the tank return line 85 and also to control the pilot signal through the pilot line 82 to the compensator 20.

In embodiments, the tank 30 can be any suitable tank known to those skilled in the art. In embodiments, the tank 30 comprises a reservoir of hydraulic fluid which can be drawn into the pump 15 in order to generate a flow of hydraulic fluid for the system 10.

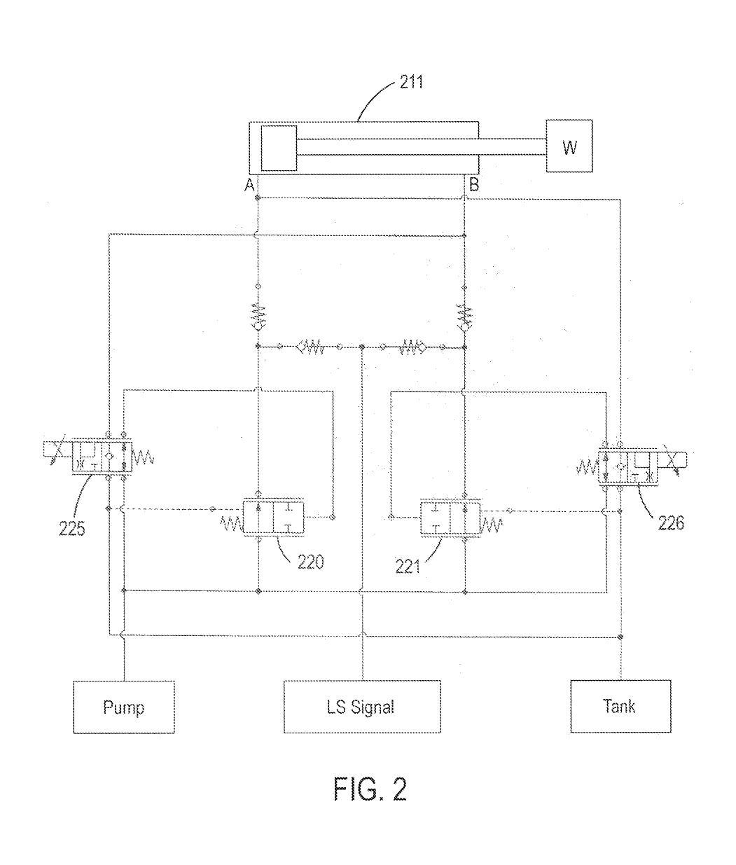

Referring to FIG. 2, another embodiment of a hydraulic actuator control system 210 constructed in accordance with principles of the present disclosure is shown. The hydraulic actuator control system 210 includes separate meter-in and meter-out devices for each side of the actuator 211. The hydraulic actuator control system 210 includes a pair of compensators 220, 221, one for each side of the actuator 11 for meter-in control, and a pair of poppet-type proportional valves 225, 226, one for each side of the actuator 211 for meter-out control. The poppet valves 225, 226 have an additional set of lines to send a signal of pump pressure when in neutral or meter-out load pressure when shifted. When load pressures are sent to the respective compensator 220, 221, the compensator 220, 221 is adapted to monitor the pressure differential across the meter out valve 225, 226.

The first and second compensators 220, 221 are interposed between the Pump and the first and second ports A, B of the actuator 211, respectively. The first and second compensators 225, 226 are each configured to be movable between a pump position and an isolated position. The Pump is in fluid communication with the first port A of the actuator when the first compensator 220 is in the pump position, and the Pump is fluidly isolated from both the first and second ports A, B of the actuator 211 when the first compensator 220 is in the isolated position. The Pump is in fluid communication with the second port B of the actuator 211 when the second compensator 221 is in the pump position, and the Pump is fluidly isolated from both the first and second ports A, B of the actuator 211 when the second compensator 221 is in the isolated position.

The first and second proportional valves 225, 226 are interposed between the Tank and the first and second ports A, B of the actuator 211, respectively. The first proportional valve 225 is configured to be movable between a second port fill position and a second port drain position. The Tank is in one-way fluid communication with the second port B of the actuator 211 when the first proportional valve 225 is in the second port fill position. The second port B of the actuator 211 is in fluid communication with the Tank via an orifice when the first proportional valve 225 is in the second port drain position.

The second proportional valve 226 is configured to be movable between a first port fill position and first port drain position. The Tank is in one-way fluid communication with the first port A of the actuator 211 when the second proportional valve 226 is in the first port fill position. The first port A of the actuator 211 is in fluid communication with the Tank via an orifice when the second proportional valve 226 is in the first port drain position.

The first and second proportional valves 225, 226 are in respective pilot communication with the first and second compensators 220, 221, respectively, so that the first and second compensators 220, 221 are adapted to monitor a pressure differential across the first and second proportional valves 225, 226, respectively, of the return flow of fluid moving to the Tank, and so that the first and second compensators 220, 221 are adapted to control the flow of fluid from the Pump to the first and second ports A, B of the actuator 211, respectively, based upon the pressure differential across the first and second proportional valves 225, 226, respectively.

The hydraulic actuator control system 210 of FIG. 2 can be functionally similar in other respects to the hydraulic actuator control system 10 of FIG. 1. Other details concerning the structural features and operation of the hydraulic actuator control system 210 of FIG. 2 will be apparent to one skilled in the art upon review of FIG. 2.

In embodiments, a hydraulic actuator control system constructed according to principles of the present disclosure can provide a relatively low leakage solution. In embodiments, a hydraulic actuator control system constructed according to principles of the present disclosure can help reduce pressure loss. Meter-out pressure losses can be hydro-mechanically controlled to a low fixed rate determined by the compensator's spring. In comparison, the pressure drop from the actuator to the tank in a traditional spool system or counterbalance system can be relatively higher depending on operation mode.

In embodiments, a hydraulic actuator control system constructed according to principles of the present disclosure can be used with a relatively smaller manifold size and help achieve a lower weight system. In embodiments, components of a hydraulic actuator control system constructed according to principles of the present disclosure can be sized to match actuator volumes, which can be helpful when used with an actuator having a large ratio. In embodiments, a hydraulic actuator control system constructed according to principles of the present disclosure can have a reduced overall system cost relative to prior systems such as a four-coil bridge circuit. In embodiments, a hydraulic actuator control system constructed according to principles of the present disclosure can comprise a distributed control system. In embodiments, a hydraulic actuator control system constructed according to principles of the present disclosure can be applied to a multi-function machine where several actuators are simultaneously controlled.

In embodiments of a method of controlling a hydraulic actuator following principles of the present disclosure, any system according to principles of the present disclosure can be used to control the actuator as described herein. In one embodiment, a method of controlling a hydraulic actuator following principles of the present disclosure includes directing a flow of fluid from a pump through a meter-in device to a chamber within an actuator via a first port. In response to the flow of fluid entering the first port of the actuator, a return flow of fluid is directed from a second port of the actuator through a meter-out device to a tank. The meter-in device monitors a pressure differential across the meter-out device. The meter-in device controls the flow of fluid from the pump to the actuator to place the pressure differential across the meter-out device within a desired range.

In embodiments, monitoring the pressure differential includes referencing pressure in a pilot port of a compensator to pressure at the second port of the actuator. In embodiments, other variations and refinements of the steps listed herein can be made using an embodiment of a hydraulic actuator control system constructed according to principles of the present disclosure.

In embodiments, the method further comprises allowing a piston assembly of the actuator to move to a retracted position by the action of gravity without the powered-operation of the pump. In embodiments, the piston assembly is allowed to move to the retracted position without the operation of an ECU sending a command signal.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A hydraulic actuator control system, the hydraulic actuator control system comprising:
a tank, the tank adapted to hold a reservoir of fluid;
a pump, the pump in fluid communication with the tank, the pump adapted to receive a supply of fluid from the tank and to discharge a flow of fluid;
an actuator, the actuator in selective fluid communication with the pump and the tank, the actuator defining a first port, a second port, and a chamber therein, the first and second ports in communication with the chamber, the chamber adapted to receive the flow of fluid from the pump;
a meter-in device, the meter-in device interposed between the pump and the actuator, the meter-in device adapted to selectively direct the flow of fluid from the pump to at least one of the first and second ports of the actuator;
a meter-out device, the meter-out device interposed between the actuator and the tank, the meter-out device is adapted to selectively direct a return flow of fluid from at least the other of the first and second ports of the actuator to the tank;
wherein the meter-in device is adapted to monitor a pressure differential across the meter-out device of the return flow of fluid moving to the tank, and wherein the meter-in device is adapted to control the flow of fluid from the pump to the actuator based upon the pressure differential across the meter-out device.

2. The hydraulic actuator control system of claim 1, wherein the meter-out device includes an orifice through which the return flow of fluid passes.

3. The hydraulic actuator control system of claim 1, wherein the meter-in device comprises a compensator, and the meter-out device comprises a proportional directional control valve, the compensator being in fluid communication with the proportional directional control valve such that the compensator is adapted to selectively direct the flow of fluid from the pump to the proportional directional control valve, and the proportional directional control valve is adapted to selectively direct the flow of fluid from the compensator to one of first and second ports of the actuator and to direct the return flow of fluid from the other of the first and second ports of the actuator to the tank.

4. The hydraulic actuator control system of claim 3, wherein the proportional directional control valve includes a respective orifice adapted to meter the return flow of fluid out of the first port and the second port of the actuator to the tank.

5. The hydraulic actuator control system of claim 4, wherein the directional control valve and the compensator are selectively fluidly connected such that the respective orifice through which the return flow of fluid is passing is also fluidly connected to the compensator.

6. The hydraulic actuator control system of claim 5, wherein the compensator includes a pump port, a control valve inlet port, a tank port, a first pilot port, and a second pilot port, and wherein the directional control valve includes an inlet port, a meter-out port, a compensator port, a first work port, and a second work port, and a load sense port, wherein:
the pump port of the compensator being fluidly connected to the pump, the control valve inlet port of the compensator being in fluid communication with the inlet port of the directional control valve, the tank port of the compensator being fluidly connected to the tank, the first pilot port of the compensator being in fluid communication with the meter-out port of the directional control valve, the second pilot port of the compensator being in fluid communication with the compensator port of the directional control valve, and
the meter-out port of the direction control valve is also in fluid communication with the tank, the first work port of the directional control valve is in fluid communication with the first port of the actuator, and the second work port of the directional control valve is in fluid communication with the second port of the actuator.

7. The hydraulic actuator control system of claim 6, wherein the directional control valve includes a load sense port, the system further comprising:
a load sense line, the load sense line being in fluid communication with the load sense port of the directional control valve, the load sense line adapted to provide a load sense signal to the pump, the pump adapted to vary the flow of fluid in response to the load sense signal to generate a desired pressure at the actuator.

8. The hydraulic actuator control system of claim 6, wherein the meter-out port of the directional control valve is downstream of the respective orifice and the compensator port of the directional control valve is upstream of the respective orifice such that the pressure in the first pilot port of the compensator is referenced to the pressure at the meter-out port of the directional control valve downstream of the respective orifice provided, and the pressure in the second pilot port is referenced to the pressure at the meter-out side of the actuator upstream of the respective orifice so that a pilot pressure difference between the first and second pilot ports corresponds to the pressure differential across the meter-out device of the return flow of fluid moving to the tank.

9. The hydraulic actuator control system of claim 8, further comprising:
a dampener device fluidly interposed between the compensator port of the directional control valve and the second pilot port of the compensator.

10. The hydraulic actuator control system of claim 8, wherein the compensator is movable between a pump position and a tank position,
when the compensator is in the pump position, the pump is in fluid communication with the control valve inlet port of the compensator through the pump position of the compensator, and the tank is fluidly isolated from the control valve inlet port, and
when the compensator is in the tank position, the tank is in fluid communication with the control valve inlet port of the compensator through the tank position of the compensator, and the pump is fluidly isolated from the control valve inlet port.

11. The hydraulic actuator control system of claim 10, wherein the compensator includes a compensator spring adapted to bias the compensator to the pump position.

12. The hydraulic actuator control system of claim 11, wherein the compensator is adapted to move to the tank position to allow the inlet port of the directional control valve to be in fluid communication with the tank to have access to tank pressure when the load-induced pressure exceeds a threshold level, and when the load-induced pressure is below the threshold level, the compensator spring is adapted to move the compensator to the pump position to achieve a desired meter-out pressure drop based upon a spring bias generated by the compensator spring.

13. The hydraulic actuator control system of claim 11, the directional control valve is movable between a first-port fill position, a second-port fill position, and a neutral position, wherein:
when the directional control valve is in the first-port fill position, the first port of the actuator is in fluid communication with one of the pump and the tank to receive a flow of fluid therein to fill the first side of the actuator with fluid, and the second port of the actuator is in fluid communication with the tank to drain fluid from the second side of the actuator to the tank,
when the directional control valve is in the second-port fill position, the second port of the actuator is in fluid communication with one of the pump and the tank to receive a flow of fluid therein to fill the second side of the actuator with fluid, and the first port of the actuator is in fluid communication with the tank to drain fluid from the first side of the actuator to the tank, and
when the directional control valve is in the neutral position, the actuator is fluidly isolated from each of the pump and the tank such that the position of the actuator is substantially held in place.

14. The hydraulic actuator control system of claim 13, the directional control valve is biased to the neutral position.

15. The hydraulic actuator control system of claim 1, comprising separate meter-in and meter-out devices for each side of the actuator.

16. The hydraulic actuator control system of claim 1, wherein the meter-in device comprises first and second compensators, and the meter-out device comprises first and second proportional valves, wherein:
the first and second compensators are interposed between the pump and the first and second ports of the actuator, respectively, the first and second compensators each configured to be movable between a pump position and an isolated position, the pump being in fluid communication with the first port of the actuator when the first compensator is in the pump position, and the pump being fluidly isolated from both the first and second ports of the actuator when the first compensator is in the isolated position, the pump being in fluid communication with the second port of the actuator when the second compensator is in the pump position, and the pump being fluidly isolated from both the first and second ports of the actuator when the second compensator is in the isolated position,
the first and second proportional valves are interposed between the tank and the first and second ports of the actuator, respectively,
the first proportional valve being configured to be movable between a second port fill position and a second port drain position, the tank being in one-way fluid communication with the second port of the actuator when the first proportional valve is in the second port fill position, and the second port of the actuator being in fluid communication with the tank via an orifice when the first proportional valve is in the second port drain position,
the second proportional valve being configured to be movable between a first port fill position and a first port drain position, the tank being in one-way fluid communication with the first port of the actuator when the second proportional valve is in the first port fill position, and the first port of the actuator being in fluid communication with the tank via an orifice when the second proportional valve is in the first port drain position,
wherein the first and second proportional valves are in respective pilot communication with the first and second compensators, respectively, so that the first and second compensators are adapted to monitor a pressure differential across the first and second proportional valves, respectively, of the return flow of fluid moving to the tank, and so that the first and second compensators are adapted to control the flow of fluid from the pump to the first and second ports of the actuator, respectively, based upon the pressure differential across the first and second proportional valves, respectively.

17. A method of controlling a hydraulic actuator, the method comprising:
directing a flow of fluid from a pump through a meter-in device to a chamber within an actuator via a first port;
in response to the flow of fluid entering the first port of the actuator, directing a return flow of fluid from a second port of the actuator through a meter-out device to a tank;
monitoring, by the meter-in device, a pressure differential across the meter-out device;
controlling, by the meter-in device, the flow of fluid from the pump to the actuator to place the pressure differential across the meter-out device within a desired range.

18. The method of claim 17, wherein monitoring the pressure differential includes referencing pressure in a pilot port of a compensator to pressure at the second port of the actuator.

19. The method of claim 17, further comprising:
allowing a piston assembly of the actuator to move to a retracted position by the action of gravity without the powered-operation of the pump.

20. The method of claim 19, wherein the piston assembly is allowed to move to the retracted position without the operation of an ECU sending a command signal.
